(19) United States
(12) Patent Application Publication
(10) Pub. No.: US 2023/0134081 A1
(43) Pub. Date: May 4, 2023

(54) SYSTEMS AND METHODS FOR MONITORING A COOKING OPERATION USING A CAMERA

(71) Applicant: Haier US Appliance Solutions, Inc., Wilmington, DE (US)

(72) Inventors: Sarah Virginia Morris, Louisville, KY (US); Matthew Hendrix, Louisville, KY (US)

(21) Appl. No.: 17/512,916

(22) Filed: Oct. 28, 2021

(51) Int. Cl. F24C 7/08; G06T 7/11; G05D 23/19

(52) U.S. Cl. CPC F24C 7/08; G06T 7/11; G05D 23/1917

(57) ABSTRACT

A method of operating an oven appliance includes capturing an image of a cooking chamber of the oven appliance, defining a plurality of zones within the cooking chamber as shown on the captured image, analyzing the image using one or more computer processors and image recognition features to determine at least one characteristic of an item within the cooking chamber within each zone, and comparing the at least one characteristic across the plurality of zones.

### FIELD OF THE INVENTION

The present subject matter relates generally to oven appliances, and more particularly to methods of operating oven appliances using artificial intelligence analysis of captured images.

### BACKGROUND OF THE INVENTION

Conventional oven appliances generally include a cabinet that includes a cooking chamber for receipt of food or other items for cooking or heating. Some oven appliances include one or more heating elements placed at varying locations within the cooking chamber to provide heat to the items therein. For instance, several different heating methods may be included within the cooking chamber, for instance, radiant heating elements, convection powered heating elements, or direct flame heating elements, to name a few. Recently, oven appliances have begun incorporating detection means within the cooking chamber to monitor a cooking progress of the food items provided therein.

The detection means may assist users in cooking applications by monitoring a cooking progression and alerting the user or users when a certain cooking level has been reached. However, the placement of the one or more heating elements may lead to uneven cooking through different areas within the cooking chamber. For instance, heat from the heating element(s) may be directed to some areas more than others, leading to some portions of the food items cooking faster or receiving more heat than other portions of the food items. Thus, certain problems exist with the current implementations.

Accordingly, a method of operating an oven appliance that obviates one or more of the above-mentioned drawbacks would be desirable. In particular, a method of operating an oven appliance to determine localized cooking progression would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating an oven appliance is provided. The oven appliance may include a cooking chamber and a camera provided within the cooking chamber. The method may include capturing, via the camera, a first image of the cooking chamber; defining, on the first image, a plurality of zones within the cooking chamber, each of the plurality of zones including a first predetermined area of the cooking chamber; analyzing, by one or more computing devices using a machine learning image recognition model, the first image to evaluate a doneness level of a cooking item in each of the plurality of zones; and comparing the doneness level of the cooking item in a first zone of the plurality of zones with the doneness level of the cooking item in a second zone of the plurality of zones, the second zone being different from the first zone.

In another exemplary aspect of the present disclosure, an oven appliance is disclosed. The oven appliance may include a cabinet defining a cooking chamber; a user interface provided on the cabinet; a camera provided within the cooking chamber and configured to capture one or more images of the cooking chamber; and a controller provided within the cabinet, the controller being operably coupled to the camera and the user interface. The controller may be configured to perform a series of operations. The series of operations may include capturing, via the camera, a first image of the cooking chamber; defining, on the first image, a plurality of zones within the cooking chamber, each of the plurality of zones including a first predetermined area of the cooking chamber; analyzing, by one or more computing devices using a machine learning image recognition model, the first image to evaluate at least one characteristic of a cooking item provided within the cooking chamber, the cooking item being divided into the plurality of zones; and comparing the at least one characteristic of the cooking item in a first zone of the plurality of zones with the at least one characteristic of the cooking item in a second zone of the plurality of zones different from the first zone.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary oven appliance with the door in a closed position according to exemplary embodiments of the present disclosure.

FIG. 2 provides a front view of an interior of a cooking chamber of an exemplary oven appliance according to exemplary embodiments of the present disclosure.

FIG. 3 provides a perspective view of a captured image of the exemplary cooking chamber of FIG. 2 according to an embodiment.

FIG. 4 provides a perspective view of a captured image of the exemplary cooking chamber of FIG. 2 according to another embodiment.

FIG. 5 provides a flow chart illustrating a method of operating an oven appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. In the context of an angle or direction, such terms include values within ten degrees greater or less than the stated direction. For example, “generally vertical” includes directions within ten degrees of vertical in any direction, e.g., clockwise or counter-clockwise.

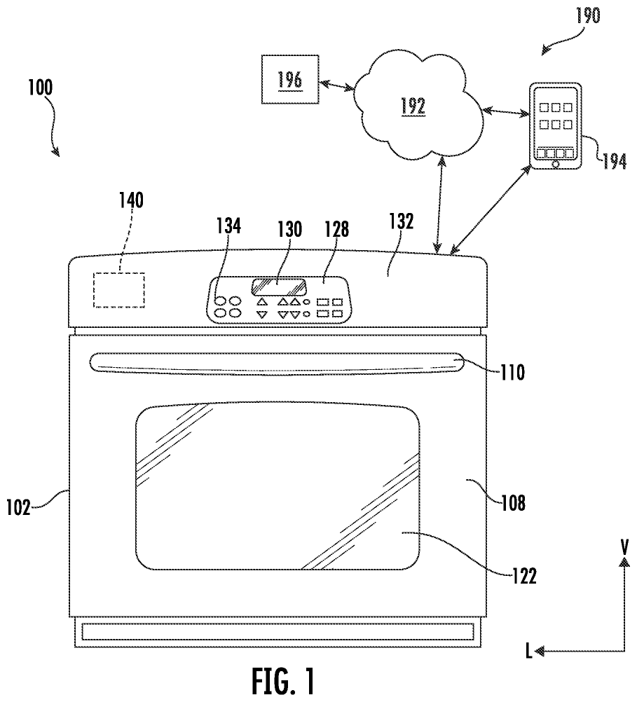

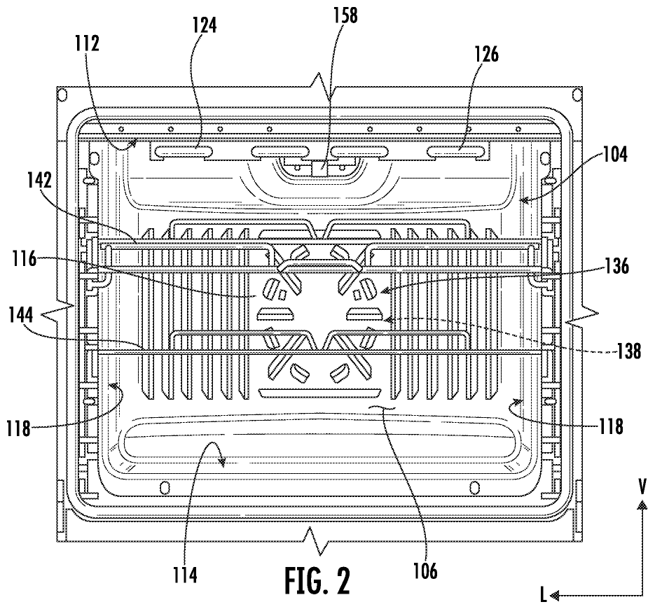

Referring to FIGS. 1 and 2, for this exemplary embodiment, oven appliance 100 may include an insulated cabinet 102 with an interior cooking chamber 104 defined by a top wall 112, a bottom wall 114, a back wall 116, and a pair of opposing side walls 118. Cooking chamber 104 is configured for the receipt of one or more items (e.g., food items) to be cooked or heated. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 may be mounted to door 108 to assist a user with opening and closing door 108. For example, a user can pull on handle 110 to open or close door 108 and access cooking chamber 104.

Oven appliance 100 may include a seal (not shown) between door 108 and cabinet 102 that assists with maintaining heat and cooking vapors within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack may be positioned in cooking chamber 104 for the receipt of food items or utensils containing food items. For example, cooking chamber 104 may include a first baking rack 142 and a second baking rack 144. Each of first baking rack 142 and second baking rack may be conveniently moved into and out of cooking chamber 104 when door 108 is open (i.e., via rails provided on each of side walls 118). First baking rack 142 may be arranged above second baking rack 144 (e.g., in the vertical direction V). Thus, first baking rack 142 may be closer to top wall 112 of cabinet 102 than second baking rack 144.

One or more heating elements may be provided at the top, bottom, or both of cooking chamber 104, and may provide heat to cooking chamber 104 for cooking. Such heating element(s) can be gas, electric, microwave, or a combination thereof. For example, in the embodiment shown in FIG. 2, oven appliance 100 includes a first top heating element 124 and a second top heating element 126, where second top heating element 126 is positioned adjacent to first top heating element 124. Other configurations with or without a wall may be used as well. For instance, a bottom heating element may be incorporated in addition or alternatively to the first and second top heating elements 124 and 126. According to some embodiments, a single top heating element is provided to supply heat to cooking chamber 104.

Oven appliance 100 may also have a convection heating element 136 and convection fan 138 positioned adjacent back wall 116 of cooking chamber 104. Convection fan 138 may be powered by a convection fan motor. Further, convection fan 138 may be a variable speed fan—meaning the speed of fan 138 may be controlled or set anywhere between and including, e.g., zero and one hundred percent (0%-100%). In certain embodiments, oven appliance 100 also includes a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 may be determined by controller 140. In addition, a sensor such as, e.g., a rotary encoder, a Hall effect sensor, or the like, may be included at the base of fan 138 to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity.

In various embodiments, more than one convection heater, e.g., a plurality of convection heating elements 136 and/or convection fans 138, may be provided. In such embodiments, the number of convection fans and convection heaters may be the same or may differ, e.g., more than one convection heating element 136 may be associated with a single convection fan 138. Similarly, top heating elements and/or bottom heating elements may be provided in various combinations, e.g., one top heating element with two or more bottom heating elements, two or more top heating elements 124, 126 with no bottom heating element, etc.

Oven appliance 100 may include a user interface 128 having a display 130 positioned on an interface panel 132 and having a variety of user input devices, e.g., controls 134. Interface 128 may allow the user to select various options for the operation of oven 100 including, e.g., various cooking and cleaning cycles. Operation of oven appliance 100 may be regulated by a controller 140 that is operatively coupled, i.e., in communication with, user interface 128, heating elements 124, 126, 136 and other components of oven 100 as will be further described.

For example, in response to user manipulation of the user interface 128, controller 140 may operate the heating element(s). Controller 140 may receive measurements from one or more temperature sensors. Controller 140 may also provide information such as a status indicator, e.g., a temperature indication, to the user with display 130. Controller 140 may also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory may store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the exemplary methods described below. Controller 140 may also be or include the capabilities of either a proportional (P), proportional-integral (PI), or proportional-integral-derivative (PID) control for feedback-based control implemented with, e.g., temperature feedback from one or more sensors.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

In the illustrated embodiments, the user input device is provided as touch type controls 134, however, it should be understood that controls 134 and the configuration of oven appliance 100 shown in FIG. 1 are illustrated by way of example only. For example, the user interface 128 may be provided as a touchscreen which provides both the display 130 and the controls 134. As further examples, the user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. In some embodiments, user interface 128 may be in communication with controller 140 via one or more signal lines or shared communication busses. In other embodiments, the user interface 128 may be configured as an external computing device or remote user interface device, such as a smart phone, tablet, or other device capable of connecting to the controller 140. For example, the remote user interface device may be a handheld user interface with a display thereon, e.g., a touchscreen display. The remote user device may connect to the controller 140 wirelessly using any suitable wireless connection, such as wireless radio, WI-FI®, BLUETOOTH®, ZIGBEE®, laser, infrared, and any other suitable device or interface. For example, in some embodiments, the remote user interface may be an application or “app” executed by a remote user interface device such as a smart phone or tablet. Signals generated in controller 140 may operate appliance 100 in response to user input via the user interface 128.

While oven 100 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

A camera 158 may be provided within cooking chamber 104. Generally, camera 158 may be a video camera or a digital camera with an electronic image sensor [e.g., a charge coupled device (CCD) or a CMOS sensor]. When assembled, camera 158 is in communication (e.g., electric or wireless communication) with controller 140 such that controller 140 may receive a signal from camera 158 corresponding to the image captured by camera 158. Camera 158 may be configured to capture images of cooking chamber 104 (e.g., an interior of cabinet 102). For instance, camera 158 may capture images of food items placed in cooking chamber 104. Camera 158 may be located in any suitable location within cooking chamber 104, such that each of a plurality of heating zones are visible to camera 158. For example, as shown in FIG. 2, camera 158 may be located at or near a top of cooking chamber 104 in the vertical direction V (e.g., at a center of cooking chamber 104 along the lateral direction L). Additionally or alternatively, camera 158 may be located at or near a center of cooking chamber 104 in the lateral direction L and the vertical direction V. The specific location of camera 158 is not limited, however, and one of ordinary skill in the art would appreciate multiple potential locations for camera 158.

Referring still to FIG. 1, a schematic diagram of an external communication system 190 will be described according to an exemplary embodiment of the present subject matter. In general, external communication system 190 is configured for permitting interaction, data transfer, and other communications with oven appliance 100. For example, this communication may be used to provide and receive operating parameters, cycle settings, performance characteristics, user preferences, user notifications, or any other suitable information for improved performance of oven appliance 100.

External communication system 190 permits controller 140 of oven appliance 100 to communicate with external devices either directly or through a network 192. For example, a consumer may use a consumer device 194 to communicate directly with oven appliance 100. For example, consumer devices 194 may be in direct or indirect communication with oven appliance 100, e.g., directly through a local area network (LAN), Wi-Fi, Bluetooth, Zigbee, etc. or indirectly through network 192. In general, consumer device 194 may be any suitable device for providing and/or receiving communications or commands from a user. In this regard, consumer device 194 may include, for example, a personal phone, a tablet, a laptop computer, or another mobile device.

In addition, a remote server 196 may be in communication with oven appliance 100 and/or consumer device 194 through network 192. In this regard, for example, remote server 196 may be a cloud-based server 196, and is thus located at a distant location, such as in a separate state, country, etc. In general, communication between the remote server 196 and the client devices may be carried via a network interface using any type of wireless connection, using a variety of communication protocols (e.g., TCP/IP, HTTP, SMTP, FTP), encodings or formats (e.g., HTML, XML), and/or protection schemes (e.g., VPN, secure HTTP, SSL).

In general, network 192 can be any type of communication network. For example, network 192 can include one or more of a wireless network, a wired network, a personal area network, a local area network, a wide area network, the internet, a cellular network, etc. According to an exemplary embodiment, consumer device 194 may communicate with a remote server 196 over network 192, such as the internet, to provide user inputs, transfer operating parameters or performance characteristics, receive user notifications or instructions, etc. In addition, consumer device 194 and remote server 196 may communicate with oven appliance 100 to communicate similar information.

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more appliances, other communication protocols and steps may be implemented, etc. These variations and modifications are contemplated as within the scope of the present subject matter.

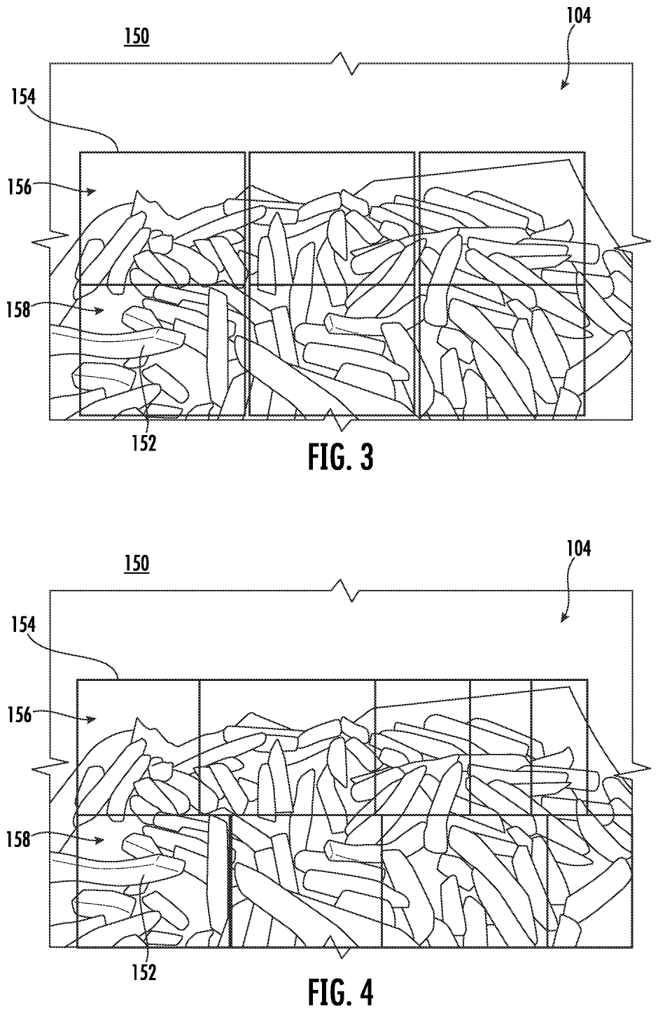

Referring now to FIG. 3, an exemplary schematic of a captured image 150 within cooking chamber 104 will be described in detail. For instance, upon capturing an image 150 of cooking chamber 104, the image 150 may be transmitted to controller 140 for analysis. Controller 140 may perform one or more image analysis or image recognition operations on the captured image 150. For instance, controller 140 may analyze the image 150 to determine a level of doneness to one or more items 152 (e.g., food items) provided within cooking chamber 104. As used herein, the term “doneness” and the like are generally intended to refer to a cooked or heated level of a food item 152. For instance, controller 140 may determine a doneness of the food item 152 by determining a color change difference after a predetermined amount of time, a temperature level (e.g., as determined by a temperature sensor, an infrared sensor, etc.), a level of crisp on a food item coating, or the like. In some embodiments, controller 140 may assign a scale number, such as from 1 to 10, with 1 being a lower level of doneness and 10 being a higher level of doneness, to the food item 152. Moreover, the “doneness” may refer to any qualitative or quantitative aspect of the food item 152 throughout the cooking process. It should be appreciated that controller 140 may continually monitor the food item 152 throughout the cooking process (or operation) to continually track the level of doneness or cooked level.

Further, as shown in FIG. 3, controller 140 may divide or section the captured image 150 into a plurality of zones 154. In detail, the image 150 may capture an entire area in which the food item 152 or food items are provided, and may subsequently define a plurality of zones 154, each zone having a portion of the food item 152 focused therein. The plurality of zones 154 may be tagged and assigned within controller 140. For instance, the plurality of zones 154 may be provided as a grid, as seen in FIG. 3. In at least some embodiments, each of the plurality of zones 154 is identical in size. Thus, controller 140 may determine or approximate an amount of the food item 152 in each zone.

In another embodiment, the size of each of the plurality of zones 154 may be dynamic. In detail, the size of each zone 154 may change over time. For instance, controller 140 may continually analyze captured images 150 (or a video feed) of cooking chamber 104 and determine a cooking rate of each zone 154. When a first zone 156 is determined to have an identical cooking rate as a second zone 157, controller 140 may merge the first zone 156 and the second zone 157 together to create, for example, a third zone. Thus, controller 140 may subsequently monitor the third zone to keep track of the cooking rate and doneness of the food item 152 therein.

In another embodiment, as seen in FIG. 4, controller 140 may determine that the first zone 156 is displaying different levels of doneness or different cooking rates within its own boundaries. Controller 140 may then split the first zone 156 into two smaller zones and monitor each of the smaller zones individually. Accordingly, each of the plurality of zones 154 may be dynamically provided and may change size throughout a cooking operation. Advantageously, a more accurate prediction of doneness of the food item 152 may be generated by analyzing more finely tuned areas of cooking.

Now that the construction of oven appliance 100 and the configuration of controller 140 according to exemplary embodiments have been presented, an exemplary method 200 of operating an oven appliance will be described. Although the discussion below refers to the exemplary method 200 of operating oven appliance 100, one skilled in the art will appreciate that the exemplary method 200 is applicable to the operation of a variety of other oven appliances, such as toaster ovens. In exemplary embodiments, the various method steps as disclosed herein may be performed by controller 140 or a separate, dedicated controller.

Prior to performing method 200, a cooking operation may be initiated by a user by inserting an item (such as a food item) into a cooking chamber (e.g., cooking chamber 104) of an oven appliance (e.g., oven appliance 100). The user may then start one of a plurality of cooking operations, for instance, via a user interface (e.g., user interface 128).

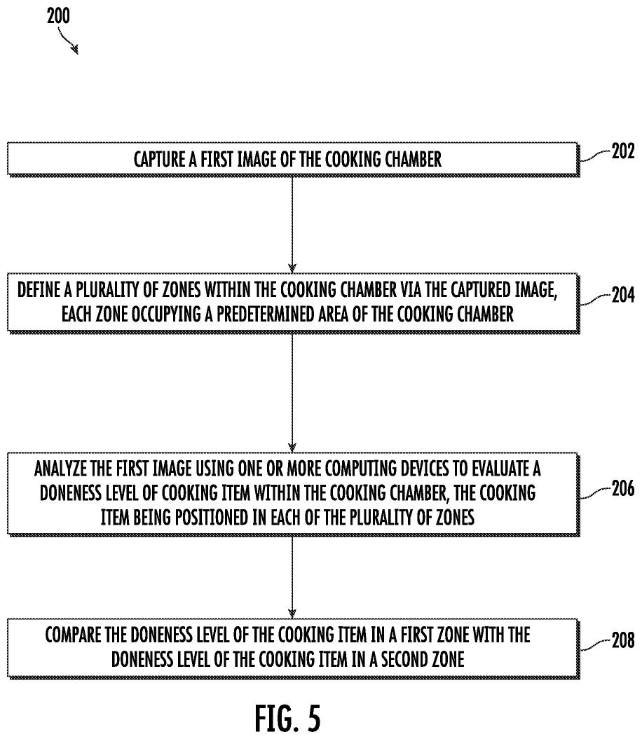

Referring now to FIG. 5, step 202 of method 200 may include capturing a first image of the cooking chamber. In detail, a camera (e.g., camera 158) may capture a first image of a food item within the cooking chamber of an oven appliance (e.g., oven appliance 100). As described above, the camera may be configured to take a series of pictures throughout the cooking operation. According to exemplary embodiments, the camera may capture one or more still images, one or more video clips, a live stream, or any other suitable type and number of images suitable for analysis of the cooking operation. It should be appreciated that the images obtained by the camera may vary in number, frequency, angle, resolution, detail, etc. in order to improve the clarity of the cooking chamber and/or the food item(s). In addition, according to exemplary embodiments, the controller may be configured for illuminating the cooking chamber using one or more light sources just prior to obtaining images. According to still other embodiments, the one or more light sources may remain off if the camera can obtain suitable images without extra light. For example, if the ambient lighting in a room is sufficient to illuminate the cooking chamber such that the camera may obtain a suitable image facilitating the analysis described herein, the one or more light sources may remain off altogether.

At step 204, method 200 may include defining, on the first image, a plurality of zones within the cooking chamber, each of the plurality of zones occupying a predetermined area of the cooking chamber. As discussed above, the controller may define a plurality of zones on the image that equate to zones within the cooking chamber, each of the plurality of zones containing a predetermined amount of the food item (or food items) within the cooking chamber. In addition, according to exemplary embodiments, the zones may be defined only to include portions of the cooking utensil that contain the food item, e.g., omitting portions of a cooking tray that are empty. The number of zones that controller defines may be arbitrary, and may depend on a size of the food item in the cooking chamber, a type of food item, a number of food items, a temperature before cooking of the food item, or the like. Moreover, a size of each of the plurality of zones may be arbitrarily defined, and may be based on similar attributes as described above (e.g., size, type, number, pre-cooked temperature, etc. of the food item). Additionally or alternatively, as discussed above, each of the plurality of zones may be dynamic in nature. In detail, the controller may adjust a size, shape, and/or number of zones within the captured image throughout the cooking operation.

At step 206, method 200 may include analyzing, by one or more computing devices using a machine learning image recognition model, the first image to evaluate one or more characteristics of the cooking item provided within the cooking chamber. At least a portion of the cooking item may be positioned in each of the plurality of zones. Moreover, the one or more characteristics may include, for example, a doneness level of the food item. It should be appreciated that any suitable image processing or recognition method may be used to analyze the images captured at step 202 and facilitate evaluation of the doneness level. In addition, it should be appreciated that this image analysis or processing may be performed locally (e.g., by controller 140) or remotely (e.g., by a remote server).

According to exemplary embodiments of the present subject matter, step 206 of analyzing the one or more images may include analyzing the image(s) of the food item (or cooking chamber) using a neural network classification module and/or a machine learning image recognition process. In this regard, for example, the controller may be programmed to implement the machine learning image recognition process that includes a neural network trained with a plurality of images of a cooking chamber including various food items, food items at different levels of doneness, etc. By analyzing the image(s) captured using this machine learning image recognition process, the controller may properly evaluate the one or more characteristics of the food item or cooking chamber, e.g., by identifying the trained image that is closest to the obtained image.

As used herein, the terms image recognition process and similar terms may be used generally to refer to any suitable method of observation, analysis, image decomposition, feature extraction, image classification, etc. of one or more images or videos taken within an oven appliance. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by the camera and the controller may be programmed to perform such processes and take corrective action.

According to an exemplary embodiment, controller may implement a form of image recognition called region based convolutional neural network (“R-CNN”) image recognition. Generally speaking, R-CNN may include taking an input image and extracting region proposals that include a potential object, such as a particular region containing a food item or the like. In this regard, a “region proposal” may be regions in an image that could belong to a particular object, such as a particular shape of food item. For instance, each identified zone of the plurality of zones may represent a “region proposal.” Moreover, individual “region proposals” may further be defined within each zone of the plurality of zones. A convolutional neural network may then be used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image (or a particular zone of the image) into segments (e.g., into groups of pixels containing similar attributes) that may be analyzed independently or in parallel to obtain a more detailed representation of the object or objects in an image. This may be referred to herein as “Mask R-CNN” and the like.

According to still other embodiments, the image recognition process may use any other suitable neural network process. For example, step 206 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to analyze the image to determine various attributes or characteristics of the cooking chamber or food item. In addition, a K-means algorithm may be used. Other image recognition processes are possible and within the scope of the present subject matter.

It should be appreciated that any other suitable image recognition process may be used while remaining within the scope of the present subject matter. For example, step 206 may include using a deep belief network (“DBN”) image recognition process. A DBN image recognition process may generally include stacking many individual unsupervised networks that use each network's hidden layer as the input for the next layer. According to still other embodiments, step 206 may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence (“AI”) analysis techniques, and combinations of the above described or other known methods may be used while remaining within the scope of the present subject matter.

According to exemplary embodiments, the image analysis may be performed independently within each defined zone of the plurality of zones defined in the image. As discussed above, the image analysis may monitor and determine various attributes of the food item that may define doneness, such as a color or color change of the food item, a texture change of the food item, an instantaneous temperature of the item, or the like. Further, each zone may be tagged or labeled with a code representing the level of doneness within that zone. The code may be numerical, and/or may represent a quantitative or qualitative evaluation of the doneness of the food item within that zone. Each image captured may then be stored in a database for future machine learning and further calibration of the image analysis software. Accordingly, the controller may build a database or library of images to use in defining doneness levels (or other characteristics of food items).

At step 208, method 200 may include comparing the at least one characteristic (e.g., doneness level) of the food item in a first zone of the plurality of zones with the at least one characteristic of the food item in a second zone of the plurality of zones. The second zone may be different from the first zone. In some embodiments, each identified zone is compared with every other identified zone within the image. Accordingly, the controller may determine a level of doneness within each identified zone, accurately determining which zones are cooking faster than the rest. For instance, the controller may utilize the comparisons to make predictions on the cooking operation.

In detail, the controller may determine that the doneness level of the food item in the first zone is different from the doneness level of the food item in the second zone. Thus, the controller may predict that the food item located within the first zone will provide a desired level of doneness before the food item located within the second zone. Additionally or alternatively, the controller may determine that multiple zones have similar doneness levels. The controller may then determine that one area (or group of zones) is cooking faster (or slower) than one or more other areas of the cooking chamber.

Upon determining that the doneness level of the food item within the first zone is different from the doneness level of the food item within the second zone (and subsequently predicting the cooking times), the controller may provide an alert to the user as to the determination. For instance, the controller may transmit a prompt to the user including information regarding the doneness levels. The prompt may be transmitted to the user interface of the oven appliance. In some embodiments, the prompt is transmitted to a mobile device registered to the user. For instance, the mobile device may be a mobile telephone, a tablet, a laptop, a smartwatch, or the like. The alert (or prompt) may include a recommended action.

For instance, the recommended action may be suggesting to the user to adjust a positioning of the food item(s) within the cooking chamber. In at least one example, if the food item has a higher doneness level in the first zone than the food item in the second zone, the recommended action includes suggesting to the user to move the food item provided in the first zone to the second zone, and vice versa. Other alerts and recommendations may be included, such as a recommendation to lower or raise a temperature of the cooking chamber (e.g., via the heating elements). It should be understood that a variety of recommendations may be presented to the user, and the disclosure is not limited to those described herein.

Additionally or alternatively, the controller may determine that one or more of the defined zones have identical characteristics, such as doneness level. In detail, upon performing the analysis of each zone within the image, the controller may determine that, for example, the first zone and the second zone are exhibiting the same doneness level. The controller may subsequently merge the first zone with the second zone, creating a third zone. Accordingly, the controller may determine that the level of doneness is progressing similarly within the first zone and the second zone. Advantageously, the newly created third zone may streamline the detection and monitoring process, e.g., of the doneness level of the food item.

According to another embodiment, the controller may continually compare captured images with each other to determine a rate of change of at least one characteristic, such as the doneness level. For instance, as discussed above, the camera may capture a first image and a second image spaced apart by a predetermined amount of time. The predetermined amount of time may range from a few seconds to a few minutes according to specific embodiments. The controller may then compare the first image with the second image to determine a rate of change of the doneness of the food item from the first image to the second image. In particular, the controller may compare the rate of change within each defined zone. Accordingly, the controller may determine that the rate of change of doneness within the first zone is different from the rate of change of doneness within the second zone. Similar to the embodiment described above, the controller may provide a recommendation to the user in response to making this determination. Further, the controller may make a prediction as to the completion of the cooking operation within each zone via the determined rate of change of doneness. Advantageously, the controller may alert the user as to the cooking progression and recommend a time to remove the food item from the cooking chamber, a modification of the cooking operation, or a better positioning of the food item within the cooking chamber.

According to the above-described embodiments, an oven appliance may monitor a cooking operation utilizing a camera within the cooking chamber. The camera may be configured to capture one or more images of food items within the cooking chamber during a cooking operation. A controller may perform one or more analyses on the captured images to determine a doneness level of the food item, or a rate of change of the doneness level of the food item. Particularly, the controller may divide the captured image into a plurality of zones, each of the plurality of zones being analyzed separately. The controller may then compare the analyses of each zone with each other to determine areas where cooking is happening faster or where more heat is being applied. The controller may then recommend a course of action to a user to avoid the food item being improperly cooked or burnt. Thus, by analyzing separate zones independently, a more accurate assessment of the cooking operation may be performed, and a more satisfactory food item may be presented after the cooking operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an oven appliance, the oven appliance comprising a cooking chamber and a camera provided within the cooking chamber, the method comprising:
capturing, via the camera, a first image of the cooking chamber;
defining, on the first image, a plurality of zones within the cooking chamber, each of the plurality of zones comprising a first predetermined area of the cooking chamber;
analyzing, by one or more computing devices using a machine learning image recognition model, the first image to evaluate a doneness level of a cooking item in each of the plurality of zones; and
comparing the doneness level of the cooking item in a first zone of the plurality of zones with the doneness level of the cooking item in a second zone of the plurality of zones, the second zone being different from the first zone.

2. The method of claim 1, wherein the machine learning image recognition model comprises at least one of a convolution neural network (“CNN”), a region-based convolution neural network (“R-CNN”), a deep belief network (“DBN”), or a deep neural network (“DNN”) image recognition process.

3. The method of claim 1, further comprising:
determining that the doneness level of the cooking item in the first zone is different from the doneness level of the cooking item in the second zone; and
alerting a user as to the determination, wherein alerting the user comprises providing a recommended course of action.

4. The method of claim 3, wherein analyzing the first image to evaluate the doneness level of the cooking item comprises comparing the first image against one or more libraries of stored images via the machine learning image recognition model.

5. The method of claim 3, wherein the recommended course of action comprises adjusting a positioning of the cooking item within the cooking chamber.

6. The method of claim 3, wherein alerting the user comprises transmitting a prompt comprising the recommended course of action to a mobile device, the mobile device being in remote communication with the oven appliance.

7. The method of claim 1, further comprising:
determining that the doneness level of the cooking item in the first zone is the same as the doneness level of the cooking item in the second zone; and
combining the first zone into the second zone to create a third zone.

8. The method of claim 1, further comprising:
capturing, via the camera, a second image of the cooking chamber, the second image being captured a predetermined amount of time after capturing the first image;
analyzing, via the one or more computing devices using the machine learning image recognition model, the second image to evaluate the doneness level of the cooking item provided within the cooking chamber; and
determining a rate of change of the doneness level within each zone between the first image and the second image.

9. The method of claim 8, further comprising:
determining that the rate of change of the doneness level in a first zone is greater than the rate of change of the doneness level in a second zone, the second zone being different from the first zone; and
alerting a user as to the determination, wherein alerting the user comprises providing a recommended course of action.

10. The method of claim 9, wherein the recommended course of action comprises adjusting a positioning the cooking item within the cooking chamber.

11. An oven appliance; comprising:
a cabinet defining a cooking chamber;
a user interface provided on the cabinet;
a camera provided within the cooking chamber and configured to capture one or more images of the cooking chamber; and
a controller provided within the cabinet, the controller being operably coupled to the camera and the user interface, wherein the controller is configured to perform a series of operations, the series of operations comprising:
capturing, via the camera, a first image of the cooking chamber;
defining, on the first image, a plurality of zones within the cooking chamber, each of the plurality of zones comprising a first predetermined area of the cooking chamber;
analyzing, by one or more computing devices using a machine learning image recognition model, the first image to evaluate at least one characteristic of a cooking item provided within the cooking chamber, the cooking item being divided into the plurality of zones; and
comparing the at least one characteristic of the cooking item in a first zone of the plurality of zones with the at least one characteristic of the cooking item in a second zone of the plurality of zones different from the first zone.

12. The oven appliance of claim 11, wherein the machine learning image recognition model comprises at least one of a convolution neural network (“CNN”), a region-based convolution neural network (“R-CNN”), a deep belief network (“DBN”), or a deep neural network (“DNN”) image recognition process.

13. The oven appliance of claim 11, wherein the series of operations further comprises:
determining that the at least one characteristic of the cooking item in the first zone is different from the at least one characteristic of the cooking item in the second zone; and
alerting a user as to the determination, wherein alerting the user comprises providing a recommended course of action.

14. The oven appliance of claim 13, wherein the at least one characteristic is a doneness level of the cooking item.

15. The oven appliance of claim 13, wherein the recommended course of action comprises adjusting a positioning of the cooking item within the cooking chamber.

16. The oven appliance of claim 13, wherein alerting the user comprises transmitting a prompt comprising the recommended course of action to a mobile device, the mobile device being in remote communication with the oven appliance.

17. The oven appliance of claim 11, wherein the series of operations further comprises:
determining that the at least one characteristic of the cooking item in the first zone is the same as the at least one characteristic of the cooking item in the second zone; and
combining the first zone into the second zone to create a third zone.

18. The oven appliance of claim 11, wherein the series of operations further comprises:
capturing, via the camera, a second image of the cooking chamber, the second image being captured a predetermined amount of time after capturing the first image;
analyzing, via the one or more computing devices using the machine learning image recognition model, the second image to evaluate the at least one characteristic of the cooking item provided within the cooking chamber; and
determining a rate of change of the at least one characteristic within each zone between the first image and the second image.

19. The oven appliance of claim 18, wherein the series of operations further comprises:
determining that the rate of change of the at least one characteristic in a first zone is greater than the rate of change of the at least one characteristic in a second zone, the second zone being different from the first zone; and
alerting a user as to the determination, wherein alerting the user comprises providing a recommended course of action.

20. The oven appliance of claim 19, wherein the recommended course of action comprises adjusting a positioning the cooking item within the cooking chamber.
